(19) United States
(12) Patent Application Publication
(10) Pub. No.: US 2020/0274786 A1
(43) Pub. Date: Aug. 27, 2020

(54) APPARATUS AND METHOD FOR MANAGING MESSAGE TRANSMISSION DELAY

(71) Applicant: SAMSUNG SDS CO., LTD., Seoul (KR)

(72) Inventor: Hee-Tae YOON, Seoul (KR)

(21) Appl. No.: 16/754,527

(22) PCT Filed: May 22, 2019
(86) PCT No.: PCT/KR2019/006138

§ 371 Date: Apr. 8, 2020

(30) Foreign Application Priority Data
May 31, 2018 (KR) 10-2018-0062318

(51) Int. Cl. H04L 12/26; H04L 29/08; H04J 3/06

(52) U.S. Cl. CPC H04L 43/0864; H04L 43/10; H04J 3/0658; H04L 67/26; H04L 43/067

(57) ABSTRACT

An apparatus for managing a message transmission delay according to an embodiment of the present invention includes a time difference calculator for obtaining local time information about a message server and calculating, based on the obtained local time information, a time difference between the local time of the message server and the local time of a client device, and a delay time calculator for calculating, when the client device receives, from the message server, a push message including transmission time information based on the local time of the message server, a delay time for the push message based on reception time information of the push message based on the local time of the client device, transmission time information included in the push message, and the time difference.

### TECHNICAL FIELD

Embodiments of the present invention relate to a technology for determining and managing message transmission delay.

### BACKGROUND ART

In the conventional mobile message service, a push message is transmitted to a client device by using a push service to notify that there is a message to receive, and the client device that has received the push message is configured to read the received message by accessing a message server.

In the conventional mobile message service, it is not possible to determine whether a message is delayed until a client device receives a push message, and only the simple transmission delay can be determined since the message transmission delay can only be measured by the time difference between when a server transmits the push message and when the client device accesses a message server and reads the message.

Accordingly, there is a need for a method for allowing a client device to determine a message transmission delay caused by an issue in setting a network area and a client device and thereby actively cope with the message transmission delay.

### DISCLOSURE

### Technical Problem

Embodiments of the present invention provide an apparatus and method for managing message transmission delay.

### Technical Solution

According to one embodiment of the present invention, an apparatus for managing message transmission delay includes a time gap calculator configured to acquire local time information of a message server and calculate, based on the acquired local time information, a time gap between local time of the message server and local time of a client device and a delay time calculator configured to calculate, when the client device receives a push message including transmission time information based on the local time of the message server from the message server, a delay time for the push message based on reception time information of the push message based on the local time of the client device, the transmission time information included in the push message, and the time gap.

The time gap calculator may transmit a request message for requesting the local time information of the message server to the message server and receive, from the message server, a response message including the local time information of the message server and the local time information included in the response message may include a transmission time of the response message based on the local time of the message server.

The time gap calculator may calculate a round trip time (RTT) using a transmission time of the request message based on the local time of the client device and a reception time of the response message based on the local time of the client device and calculate the time gap using the transmission time of the request message, the RTT, and the transmission time of the response message.

The apparatus may further include a connection history manager configured to store network connection history information of the client device, a delay information manager configured to store message delay information regarding the push message, and a controller configured to control the client device based on at least one of the network connection history information and the message delay information.

The network connection history information may include network identification information, a connection start time, and a connection end time for each network to which the client device is connected and the message delay information may include the reception time information, the delay time, and network identification information of a network to which the client device was connected at the time when the push message was transmitted.

The delay information manager may identify, based on the reception time information, the delay time, and the network connection history information, the network to which the client device was connected at the time when the push message was transmitted.

The controller may control the client device to adjust a ping period of a push session for receiving a push message in a network to which the client device is currently connected, based on the delay time and the network identification information which are included in the message delay information.

The controller may identify a past connection holding-time of the client device for the network to which the client device is currently connected from the network connection history information, determine a network to use for push message reception among the network to which the client device is currently connected and other networks to which the client device is connectable, and control the client device to receive a push message through the determined network.

The message delay information may further include reception failure information on failure to receive the push message through the network to which the client device was connected at the time when the push message was transmitted and when the network identification information of the network to which the client device was connected at the time when the push message was transmitted is different from network identification information of a network to which the client device was connected at the time of receiving the push message, the delay information manager may determine that the reception of the push message through the network to which the client device was connected at the time when the push message was transmitted has failed.

The controller may determine, based on the delay time, the network identification information, and the reception failure information which are included in the message delay information, a network to use for push message reception among the network to which the client device is currently connected and other networks to which the client device is connectable and control the client device to receive a push message through the determined network.

The message delay information may further include doze mode state information of the client device and the delay information manager may determine that the client device is in doze mode state when the client device has failed to receive a message corresponding to the push message from the message server after receiving the push message.

The controller may control, based on the doze mode state information, the client device to provide a notification message for doze mode exception handling to a user.

According to another embodiment of the present invention, a method of managing message transmission delay includes acquiring local time information of a message server, calculating, based on the acquired local time information, a time gap between local time of the message server and local time of a client device, and calculating, when the client device receives a push message including transmission time information based on the local time of the message server from the message server, a delay time for the push message based on reception time information of the push message based on the local time of the client device, the transmission time information included in the push message, and the time gap.

The acquiring may include transmitting a request message for requesting the local time information of the message server to the message server and receiving, from the message server, a response message including the local time information of the message server and the local time information included in the response message may include a transmission time of the response message based on the local time of the message server.

The calculating of the time gap comprises calculating an RTT using a transmission time of the request message based on the local time of the client device and a reception time of the response message based on the local time of the client device, and calculating the time gap using the transmission time of the request message, the RTT, and the transmission time of the response message.

The method may further include controlling the client device based on at least one of the network connection history information and the message delay information.

The network connection history information may include network identification information, a connection start time, and a connection end time for each network to which the client device is connected and the message delay information may include the reception time information, the delay time, and network identification information of a network to which the client device was connected at the time when the push message was transmitted.

The controlling includes identifying, based on the reception time information, the delay time, and the network connection history information, the network to which the client device was connected at the time when the push message was transmitted.

The controlling may include controlling the client device to adjust a ping period of a push session for receiving a push message in a network to which the client device is currently connected, based on the delay time and the network identification information which are included in the message delay information.

The controlling may include identifying a past connection holding-time of the client device for the network to which the client device is currently connected from the network connection history information, determining a network to use for push message reception among the network to which the client device is currently connected and other networks to which the client device is connectable, and controlling the client device to receive a push message through the determined network.

The message delay information may further include reception failure information on failure to receive the push message through the network to which the client device was connected at the time when the push message was transmitted and the controlling may include, when the network identification information of the network to which the client device was connected at the time when the push message was transmitted is different from network identification information of a network to which the client device was connected at the time of receiving the push message, determining that the reception of the push message through the network to which the client device was connected at the time when the push message was transmitted has failed.

The controlling may include determining, based on the delay time, the network identification information, and the reception failure information which are included in the message delay information, a network to use for push message reception among the network to which the client device is currently connected and other networks to which the client device is connectable, and controlling the client device to receive a push message through the determined network.

The message delay information may further include doze mode state information of the client device and the controlling may include determining that the client device is in doze mode state when the client device has failed to receive a message corresponding to the push message from the message server after receiving the push message.

The controlling may include controlling, based on the doze mode state information, the client device to provide a notification message for doze mode exception handling to a user.

### Advantageous Effects

According to embodiments of the present invention, a client device that performs a message service may determine a delay time of message transmission by calculating a time gap between a message server and the client device.

In addition, according to embodiments of the present invention, the client device is allowed to actively deal with the message transmission delay using the calculated delay time of the message transmission, thereby effectively preventing the message transmission delay.

### DESCRIPTION OF DRAWINGS

FIG. 1 is a diagram illustrating a configuration of a message service system 100 according to an embodiment of the present invention.

FIG. 2 is a diagram illustrating a configuration of an apparatus for managing message transmission delay according to one embodiment of the present invention.

FIG. 3 is an exemplary diagram for describing a process of acquiring local time information of a message server according to one embodiment of the present invention.

FIG. 4 is an exemplary diagram for describing a process of receiving at a client device a push message from a message server according to one embodiment of the present invention.

FIG. 5 is a diagram illustrating a configuration of an apparatus for managing message transmission delay according to a further embodiment of the present invention.

FIG. 6 is a flowchart illustrating a method of managing message transmission delay according to one embodiment of the present invention.

FIG. 7 is a flowchart illustrating a method of managing message transmission delay according to a further embodiment of the present invention.

FIG. 8 is a block diagram for describing an example of a computing environment including a computing device suitable to be used in exemplary embodiments.

### MODE FOR INVENTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made based on the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

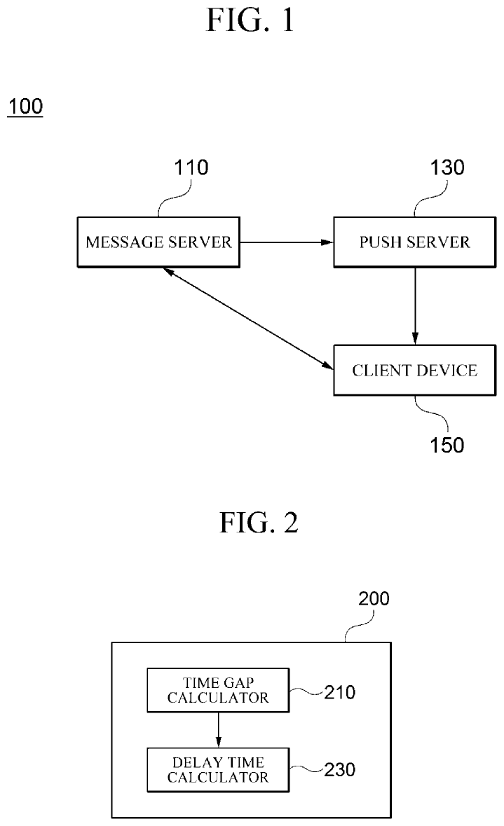

FIG. 1 is a diagram illustrating a configuration of a message service system 100 according to an embodiment of the present invention.

Referring to FIG. 1, a message service system 100 according to one embodiment of the present invention includes a message server 110, a push server 130, and a client device 150.

The message server 110 is a server of providing a message service to the client device 150. In this case, the message service is a service for transmitting and receiving a message between users using a messenger application installed in the client device 150. In this case, the messenger application means, for example, a program that allows a plurality of users to exchange messages with each other.

In detail, when the message server 110 receives a message to be transmitted to the user of the client device 150 from a specific user who uses the message service, the message server 110 may transmit a push message to the client device by requesting the push server 130 to transmit the push message for notifying that there is a message to be transmitted to the client device 150.

In addition, when the message server 110 receives a transmission request for a message corresponding to the push message from the client device 150 after transmitting the push message to the client device 150, the message server 110 may transmit the requested message to the client device 150.

The push server 130 is a server for transmitting a push message to the client device 150 at the request of the message server 110. For example, when the push server 130 receives a request to transmit a push message from the message server 110 to the client device 150, the push server 130 may transmit the push message to the client device 150.

The client device 150 is a device used by a user to receive a message service, and may be a mobile device in various forms that can be carried by a user, for example, a laptop personal computer (PC), a tablet PC, a phablet device, a personal digital assistant (PDA), a smartphone, and the like. When the client device 150 receives the push message from the push server 130, the client device 150 may request the message server 110 to transmit a message corresponding to the push message and may receive the message requested to be transmitted from the message server 110.

Meanwhile, in the example shown in FIG. 1, the client device 150 is illustrated as directly receiving the message corresponding to the push message from the message server 110, but is not necessarily limited thereto. That is, according to an embodiment, the message service system 100 may further include a proxy server (not shown) that receives and stores a message corresponding to the push message provided from the message server 110 to the client device 150. In this case, the client device 150 that has received the push message may request the proxy server to send a message corresponding to the push message and may receive, from the proxy server, the message requested to be transmitted.

FIG. 2 is a diagram illustrating a configuration of an apparatus 200 for managing message transmission delay according to one embodiment of the present invention.

The apparatus 200 for managing message transmission delay illustrated in FIG. 2 may be implemented as, for example, a configuration included in the client apparatus 150 illustrated in FIG. 1.

Referring to FIG. 2, the apparatus 200 for managing message transmission delay according to one embodiment of the present invention includes a time gap calculator 210 and a delay time calculator 230.

The time different calculator 210 obtains local time information of a message server 110 and calculates a time difference between the local time of the message server 110 and the local time of a client device 150 based on the obtained local time information. In this case, the local time of the message server 110 means the time set on the message server 110. In addition, the local time of the client device 150 means the time set on the client device 150.

According to one embodiment of the present invention, the time gap calculator 210 may transmit a request message for requesting the local time information of the message server 110 to the message server 110, and receive a response message including the local time information of the message server 110 from the message server 110.

In this case, according to one embodiment of the present invention, the local time information of the message server 110 included in the response message may include a transmission time of the response message based on the local time of the message server 110.

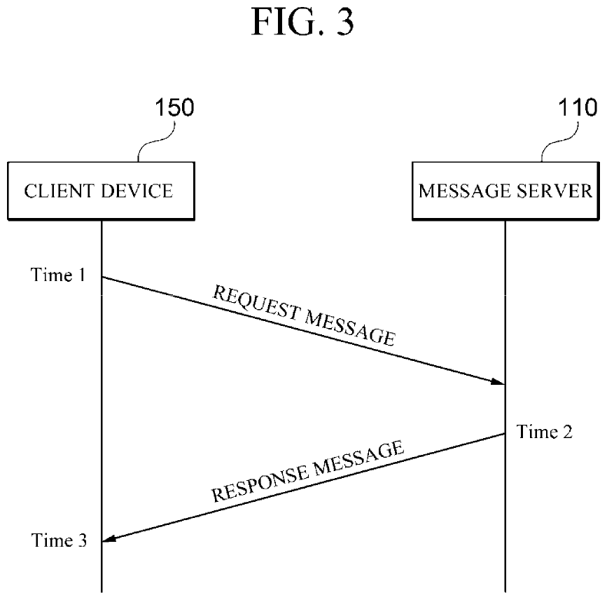

FIG. 3 is an exemplary diagram for describing a process of acquiring local time information of a message server 110 according to one embodiment of the present invention.

Referring to FIG. 3, first, the client device 150 transmits a request message for requesting local time information of the message server 110 to the message server 110, and measures and stores a transmission time Time 1 of the request message based on the local time of the client device 150.

Upon receiving the request message, the message server 110 transmits a response message including a transmission time Time 2 based on the local time of the message server 110 to the client device 150.

The client device 150 that receives the response message measures and stores a reception time Time 3 of the response message based on the local time of the client device 150.

Meanwhile, in the example shown in FIG. 3, the time gap calculator 210 may calculate a round trip time (RTT) using the transmission time Time 1 of the request message and the reception time Time 3 of the response message. In this case, the RTT refers to a time from a point in time when the request message is transmitted from the client device 150 to the message server 110 to a point in time when the client device 150 receives the response message from the message server 110. Specifically, the RTT may be calculated according to, for example, Equation 1 below.

RTT=Time 3−Time 1 [Equation 1]

In addition, the time gap calculator 210 may calculate a time gap between the client device 150 and the message server 110 using the calculated RTT, the transmission time Time 1 of the request message, and the transmission time Time 2 included in the response message. Specifically, the time gap may be calculated according to, for example, Equation 2 below.

Time Gap=Time 2−Time 1−(RTT/2) [Equation 2]

On the other hand, when the client device 150 receives, from the message server 110, the push message including the transmission time information based on the local time of the message server 110, the delay time calculator 230 calculates a delay time of the received push message based on the reception time information of the push message based on the local time of the client device 150, the transmission time information included in the received push message, and the time gap calculated by the time gap calculator 210.

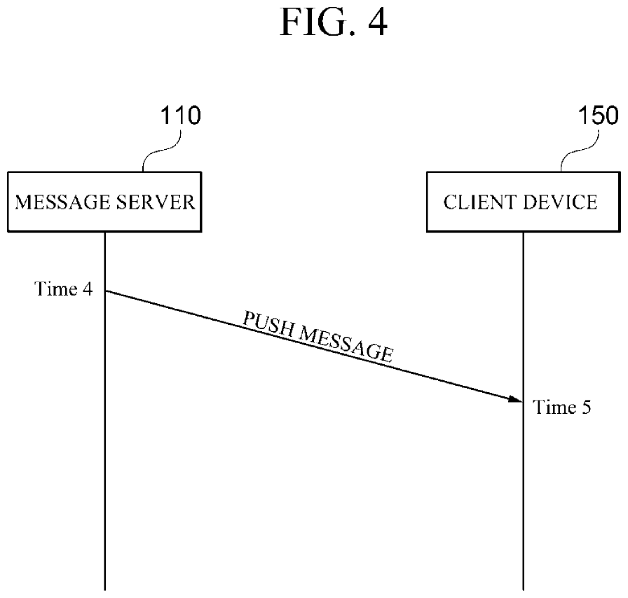

FIG. 4 is an exemplary diagram for describing a process of receiving at a client device 150 a push message from a message server 110 according to one embodiment of the present invention.

Referring to FIG. 4, first, the message server 110 transmits a push message including a transmission time Time 4 of a push message measured based on the local time of the message server 110 to the client device 150.

The client device 150 that receives the push message measures a reception time Time 5 of the push message based on the local time of the client device 150 at the moment of receiving the push message.

Meanwhile, in the example shown in FIG. 4, the delay time calculator 230 may calculate a delay time using the reception time Time 5 of the push message, the transmission time Time 4 of the push message, and the time gap calculated by the time gap calculator 210. Specifically, the delay time may be calculated using, for example, Equation 3 below.

Delay Time=Time 4−Time 5+Time Gap [Equation 3]

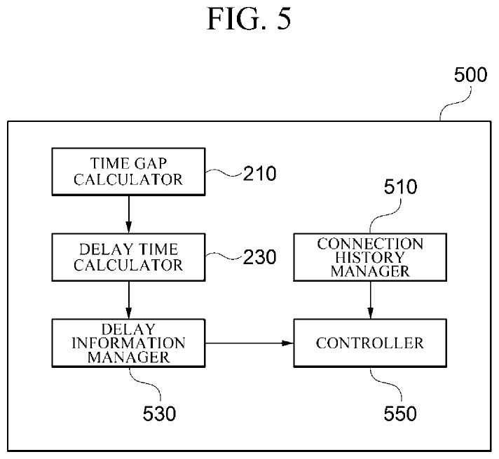

FIG. 5 is a diagram illustrating a configuration of an apparatus 500 for managing message transmission delay according to a further embodiment of the present invention.

Referring to FIG. 5, the apparatus 500 for managing message transmission delay according to a further embodiment of the present invention further includes a connection history manager 510, a delay information manager 530, and a controller 550. In the example illustrated in FIG. 5, a time gap calculator 210 and a delay time calculator 230 are the same as those illustrated in FIG. 2, and thus the redundant descriptions thereof will be omitted.

The connection history manager 510 may store network connection history information of a client device 150. In this case, the network connection history information may include information on each of the networks to which the client device 150 has been connected in the past and is currently connected.

According to one embodiment of the present invention, the network access history information may include network identification information, a connection start time, and a connection end time for each network to which the client device 150 is connected. In this case, the network identification information is to distinguish each network from other networks, and may include, for example, a basic service set identifier (BSSID).

Meanwhile, the connection start time and the connection end time are times measured based on the local time of the client device 150. For example, the connection start time is a time measured based on the local time of the client device 150 when the client device 150 is connected to the network, and the connection end time is a time measured based on the local time of the client device 150 when the client device 150 terminates its connection to the network.

The delay information manager 530 may store the message delay information regarding the push message received by the client device 150. In this case, the message delay information may include information related to the transmission delay of the push message generated in the process of transmitting the push message. Meanwhile, when the client device 150 receives a plurality of push messages, the delay information manager 530 may store message delay information for each of the plurality of push messages.

According to one embodiment of the present invention, the message delay information may include a reception time of the push message, a delay time for the push message, and network identification information of the network to which the client device 150 was connected at the time when the push message was transmitted. In this case, the reception time of the push message may be a time measured based on the local time of the client device 150 at the time when the client device 150 receives the push message.

On the other hand, the delay information manager 530 may identify the network identification information of the network to which the client device 150 was connected at the time when the push message was transmitted, based on the reception time information of the push message, the delay time for the push message, and the network connection history information.

Specifically, the delay information manager 530 may calculate, based on the local time of the client device 150, the time at which the push message is transmitted using the reception time of the push message and the delay time calculated for the push message. Thereafter, the delay information manager 530 may determine the network to which the client device 150 was connected at the time when the push message was transmitted, by using the transmission time of the push message calculated based on the local time of the client device 150 and the connection start time and connection end time of each network included in the network connection history information.

For example, it is assumed that a reception time of a push message is “4:35:43 pm” and a delay time calculated for the push message is “3 seconds”. In this case, the delay information manager 530 may calculate a time at which the push message was transmitted as “4:35:40 pm” by subtracting the delay time from the reception time of the push message. Thereafter, the delay information manager 530 may identify a network to which the client device 150 connected at “4:35:40 pm” by using the connection start time and connection end time of each network stored in the network connection history information. In addition, the delay information manager may add network identification information of the network identified from the connection history information to delay information.

Meanwhile, according to one embodiment of the present invention, the message delay information may further include reception failure information on failure to receive the push message through the network to which the client device 150 was connected at the time when the push message was transmitted.

Specifically, when the network identification information of the network to which the client device 150 was connected at the time when the push message was transmitted is different from the network identification information of the network to which the client device 150 was connected at the time of receiving the push message, the delay information manager 530 may determine that the reception of the push message through the network to which the client device 150 was connected at the time when the push message was transmitted has failed. In this case, the delay information manager 530 may obtain the network identification information of the network to which the client device 150 was connected at the time of receiving the push message, by using the reception time of the push message, and the connection start time and connection end time of each network included in the network connection history information.

In addition, according to one embodiment of the present invention, the message delay information may further include doze mode state information of the client device 150. In this case, the doze mode may refer to a function for reducing power consumption of the client device 150 by limiting network connection of the client device 150 when a preset condition is satisfied, such as when the client device 150 does not receive an input from the outside for a long time.

Specifically, according to one embodiment of the present invention, when the client device 150 fails to acquire a message corresponding to the push message from the message server 110 after receiving the push message, the delay information manager 530 may determine that the client device 150 is in doze mode state.

For example, it is assumed that the client device 150 receives a push message for notifying that there is a message to be received from the message server 110, and is connected to the message server 110 to request information on the received message. In this case, when the client device 150 fails to acquire a message corresponding to the push message, for example, when the client device 150 does not transmit a request for information on the message to the message server 110 or does not perform any action even when receiving the push message, the delay information manager 530 may determine that the client device 150 is in doze mode state and store relevant information.

On the other hand, the controller 550 may control the client device 150 based on at least one of the network connection history information of the client device 150 and the message delay information regarding the push message.

According to one embodiment of the present invention, the controller 550 may control the client device 150 to adjust a ping period of a push session for receiving a push message in the network to which the client device 150 is currently connected, based on the delay time and the network identification information which are included in the message delay information.

For example, when a ratio of the push message whose delay time is greater than or equal to a first threshold among the push messages previously received through the network to which the client device 150 is currently connected is greater than or equal to a second threshold, the controller 550 may determine that the push session timeout of the currently connected network is short. In this case, the controller 550 may control to adjust the ping period of the client device 150 to be short, thereby maintaining the push session in the currently connected network.

Also, according to another embodiment of the present invention, the controller 550 may identify, from the network connection history information, a past connection holding-time of the client device 150 with respect to the network to which the client device 150 is currently connected, and determine, based on the past connection holding-time, a network to use for push message reception among the network to which the client device 150 is currently connected and other networks to which the client device 150 is connectable. In addition, the controller 550 may control the client device 150 to receive the push message through the determined network.

For example, the controller 550 may identify the past connection holding-time of the client device 150 with respect to the network to which the client device 150 is currently connected based on the network identification information, the connection start time, and the connection end time which are included in the network connection history information. In addition, when a rate at which the past connection holding-time for the network to which the client device 150 is currently connected is less than or equal to a third threshold is greater than or equal to a fourth threshold, the controller 550 may determine that handover due to a weak electric field in the currently connected network frequently occurs. In this case, the controller 550 may control the client device 150 to connect to a network (e.g., a mobile network or the like) other than the network to which the client device 150 is currently connected.

In addition, according to another embodiment of the present invention, the controller 550 may determine a network to use for push message reception among the network to which the client device 150 is currently connected and other networks to which the client device 150 is connectable based on the delay time, the network identification information, and the reception failure information which are included in the message delay information, and control the client device 150 to receive the push message through the determined network.

In detail, the controller 550 may determine a transmission success rate of a push message through the network to which the client device 150 is currently connected by analyzing the delay time for the push messages previously received in the network to which the client device 150 is currently connected and a failure rate of the push message received through the currently connected network. For example, when the delay time of the push messages received in the network to which the client device 150 is currently connected is greater than or equal to a fifth threshold and also a ratio of the push messages that have failed to be received is greater than or equal to a sixth threshold, the controller 550 may determine that the transmission success rate of the push message through the currently connected network is low. In this case, the controller 550 may control the client device 150 to connect to a network (e.g., a mobile network or the like) other than the network to which the client device 150 is currently connected.

In addition, according to another embodiment of the present invention, the controller 550 may control the client device 150 to provide a notification message for handling a doze mode exception to a user of the client device 150 based on the doze mode state information included in the delay information regarding the push message.

In detail, when the delay information of the doze mode state information is “true” is present among the delay information on the push messages previously received by the client device 150, the controller 550 may determine that a doze mode exception handling for the message application installed in the client device 150 has not been performed. In this case, the controller 550 may provide the user of the client device 150 with a notification message for guiding that the doze mode exception handling for the message application is required to receive the push message.

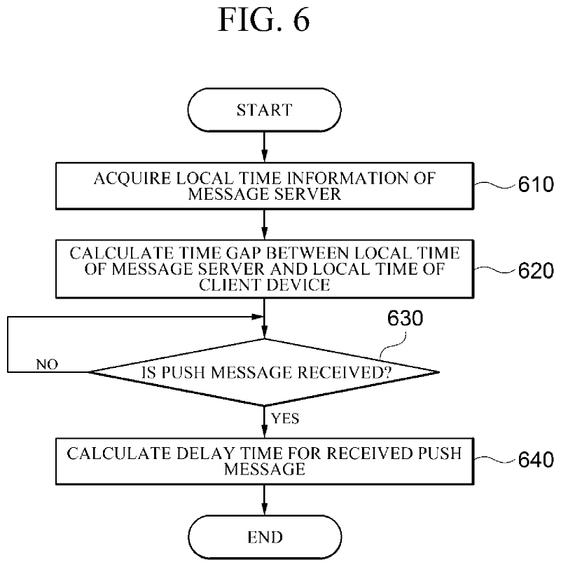

FIG. 6 is a flowchart illustrating a method of managing message transmission delay according to one embodiment of the present invention.

The method illustrated in FIG. 6 may be performed by, for example, the apparatus 200 illustrated in FIG. 2 for managing message transmission delay.

Referring to FIG. 6, the apparatus 200 for managing message transmission delay obtains local time information of the message server 110 (610).

In this case, the apparatus 200 for managing message transmission delay may transmit a request message for requesting local time information of the message server 110 to the message server 110.

In addition, the apparatus 200 for managing message transmission delay may receive a response message including the local time information of the message server 110 from the message server 110. In this case, the local time information included in the response message may include a transmission time of the response message based on the local time of the message server 110.

Thereafter, the apparatus 200 for managing message transmission delay calculates a time gap between the local time of the message server 110 and the local time of the client device 150 based on the obtained local time information (620).

At this time, the apparatus 200 for managing message transmission delay may calculate an RTT using a transmission time of the request message based on the local time of the client device 150 and a reception time of the response message based on the local time of the client device 150.

In addition, the apparatus 200 for managing message transmission delay may calculate a time gap using the transmission time of the request message based on the local time of the client device 150, the RTT, and the transmission time of the response message based on the local time of the message server 110.

Subsequently, when the client device 150 receives, from the message server 110, a push message including the transmission time information based on the local time of the message server 110 (630), the apparatus 200 for managing message transmission delay calculates a delay time for the push message based on reception time information of the push message based on the local time of the client device 150, the transmission time information included in the push message, and the time gap (640).

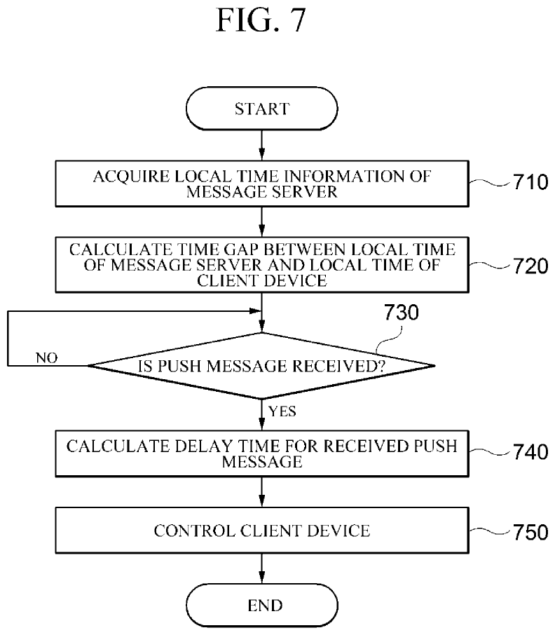

FIG. 7 is a flowchart illustrating a method of managing message transmission delay according to a further embodiment of the present invention.

The method illustrated in FIG. 7 may be performed by, for example, the apparatus 500 illustrated in FIG. 5 for managing message transmission delay.

In the example illustrated in FIG. 7, operations 710 to 740 are the same as operations 610 to 640 shown in FIG. 6, and thus redundant descriptions thereof will be omitted.

Referring to FIG. 7, the apparatus 500 for managing message transmission delay may control the client device based on at least one of network connection history information of the client device 150 and message delay information for a push message received by the client device 150 from the message server 110 (750).

In this case, according to one embodiment of the present invention, the network connection history information may include network identification information, a connection start time, and a connection end time for each network connected by the client device 150.

In addition, according to one embodiment of the present invention, the message delay information may include reception time information of a push message, delay time for the push message, and network identification information of a network to which the client device 150 was connected at the time when the push message was transmitted.

In addition, according to one embodiment of the present invention, the message delay information may further include reception failure information on failure to receive the push message through the network to which the client device 150 was connected at the time when the push message was transmitted.

In addition, according to one embodiment of the present invention, the message delay information may further include doze mode state information of the client device 150.

On the other hand, according to one embodiment of the present invention, the apparatus 500 for managing message transmission delay may control the client device 150 to adjust a ping period of a push session for receiving a push message in the network to which the client device 150 is currently connected, based on the delay time and the network identification information which are included in the message delay information.

Also, according to one embodiment of the present invention, the apparatus 500 for managing message transmission delay may identify, from the network connection history information, a past connection holding-time of the client device 150 with respect to the network to which the client device 150 is currently connected. In this case, the apparatus 500 for managing message transmission delay may determine, based on the past connection holding-time, a network to use for push message reception among the network to which the client device 150 is currently connected and other networks to which the client device 150 is connectable. In addition, the apparatus 500 for managing message transmission delay may control the client device 150 to receive the push message through the determined network.

In addition, according to one embodiment of the present invention, the apparatus 500 for managing message transmission delay may determine, based on the delay time, then network identification information, and information on whether or not the reception has failed, which are included in the message delay information, a network to use for push message reception among the network to which the client device 150 currently connected and other networks to which the client device 150 is connectable, and control the client device 150 to receive the push message through the determined network.

Also, according to one embodiment of the present invention, the apparatus 500 for managing message transmission delay may control the client device 150 to provide a notification message for doze mode exception handling to a user of the client apparatus 150 based on the doze mode state information.

In the flowcharts shown in FIGS. 6 and 7, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

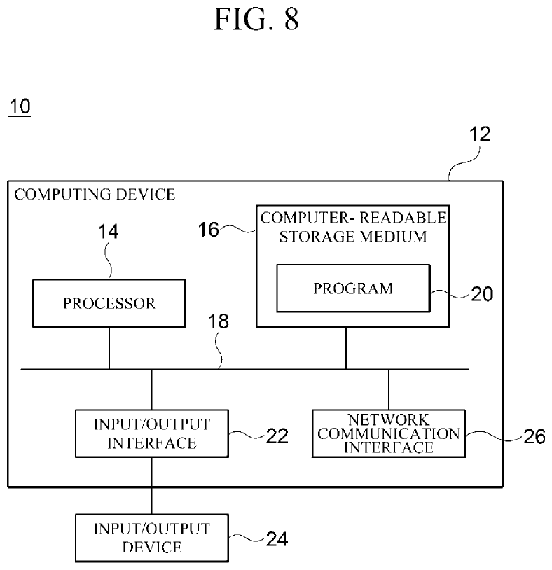

FIG. 8 is a block diagram for describing an example of a computing environment including a computing device suitable to be used in exemplary embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be one or more components included in the apparatus 200 or 500 for managing message transmission delay, for example, the time gap calculator 210, the delay time calculator 230, the connection history manager 510, the delay information manager 530, and the controller 550, which are illustrated in FIG. 2 or 5.

The computing device 12 may include at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to the exemplary embodiment.

The computer readable storage medium 16 is configured to store computer executable commands and program codes, program data and/or information in other suitable forms. The programs stored in the computer readable storage medium 16 may include a set of commands executable by the processor 14. In one embodiment, the computer readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

While representative embodiments of the preset invention have been described above in detail, it may be understood by those skilled in the art that the embodiments may be variously modified without departing from the scope of the present invention. Therefore, the scope of the present invention is defined not by the described embodiment but by the appended claims, and encompasses equivalents that fall within the scope of the appended claims.

1. An apparatus for managing message transmission delay, comprising:
a time gap calculator configured to acquire local time information of a message server and calculate, based on the acquired local time information, a time gap between local time of the message server and local time of a client device; and
a delay time calculator configured to calculate, when the client device receives a push message including transmission time information based on the local time of the message server from the message server, a delay time for the push message based on reception time information of the push message based on the local time of the client device, the transmission time information included in the push message, and the time gap.

2. The apparatus of claim 1, wherein the time gap calculator is configured to transmit a request message for requesting the local time information of the message server to the message server and receive, from the message server, a response message including the local time information of the message server, and
the local time information included in the response message comprises a transmission time of the response message based on the local time of the message server.

3. The apparatus of claim 2, wherein the time gap calculator is configured to calculate a round trip time (RTT) using a transmission time of the request message based on the local time of the client device and a reception time of the response message based on the local time of the client device and calculate the time gap using the transmission time of the request message, the RTT, and the transmission time of the response message.

4. The apparatus of claim 1, further comprising:
a connection history manager configured to store network connection history information of the client device;
a delay information manager configured to store message delay information regarding the push message; and
a controller configured to control the client device based on at least one of the network connection history information and the message delay information.

5. The apparatus of claim 4, wherein the network connection history information comprises network identification information, a connection start time, and a connection end time for each network to which the client device is connected, and
the message delay information comprises the reception time information, the delay time, and network identification information of a network to which the client device was connected at the time when the push message was transmitted.

6. The apparatus of claim 5, wherein the delay information manager is configured to identify, based on the reception time information, the delay time, and the network connection history information, the network to which the client device was connected at the time when the push message was transmitted.

7. The apparatus of claim 5, wherein the controller is configured to control the client device to adjust a ping period of a push session for receiving a push message in a network to which the client device is currently connected, based on the delay time and the network identification information which are included in the message delay information.

8. The apparatus of claim 5, wherein the controller is configured to identify a past connection holding-time of the client device for the network to which the client device is currently connected from the network connection history information, determine a network to use for push message reception among the network to which the client device is currently connected and other networks to which the client device is connectable, and control the client device to receive a push message through the determined network.

9. The apparatus of claim 5, wherein the message delay information further comprises reception failure information on failure to receive the push message through the network to which the client device was connected at the time when the push message was transmitted and
when the network identification information of the network to which the client device was connected at the time when the push message was transmitted is different from network identification information of a network to which the client device was connected at the time of receiving the push message, the delay information manager is configured to determine that the reception of the push message through the network to which the client device was connected at the time when the push message was transmitted has failed.

10. The apparatus of claim 9, wherein the controller is configured to determine, based on the delay time, the network identification information, and the reception failure information which are included in the message delay information, a network to use for push message reception among the network to which the client device is currently connected and other networks to which the client device is connectable, and control the client device to receive a push message through the determined network.

11. The apparatus of claim 5, wherein the message delay information further comprises doze mode state information of the client device and
the delay information manager is configured to determine that the client device is in doze mode state when the client device has failed to receive a message corresponding to the push message from the message server after receiving the push message.

12. The apparatus of claim 11, wherein the controller is configured to control, based on the doze mode state information, the client device to provide a notification message for doze mode exception handling to a user.

13. A method of managing message transmission delay, comprising:
acquiring local time information of a message server;
calculating, based on the acquired local time information, a time gap between local time of the message server and local time of a client device; and
calculating, when the client device receives a push message including transmission time information based on the local time of the message server from the message server, a delay time for the push message based on reception time information of the push message based on the local time of the client device, the transmission time information included in the push message, and the time gap.

14. The method of claim 13, wherein the acquiring comprises transmitting a request message for requesting the local time information of the message server to the message server; and receiving, from the message server, a response message including the local time information of the message server, and
the local time information included in the response message comprises a transmission time of the response message based on the local time of the message server.

15. The method of claim 14, wherein the calculating of the time gap comprises calculating a round trip time (RTT) using a transmission time of the request message based on the local time of the client device and a reception time of the response message based on the local time of the client device; and calculating the time gap using the transmission time of the request message, the RTT, and the transmission time of the response message.

16. The method of claim 13, further comprising controlling the client device based on at least one of the network connection history information and the message delay information.

17. The method of claim 16, wherein the network connection history information comprises network identification information, a connection start time, and a connection end time for each network to which the client device is connected and
the message delay information comprises the reception time information, the delay time, and network identification information of a network to which the client device was connected at the time when the push message was transmitted.

18. The method of claim 17, wherein the controlling comprises identifying, based on the reception time information, the delay time, and the network connection history information, the network to which the client device was connected at the time when the push message was transmitted.

19. The method of claim 17, wherein the controlling comprises controlling the client device to adjust a ping period of a push session for receiving a push message in a network to which the client device is currently connected, based on the delay time and the network identification information which are included in the message delay information.

20. The method of claim 17, wherein the controlling comprises
identifying a past connection holding-time of the client device for the network to which the client device is currently connected from the network connection history information;
determining a network to use for push message reception among the network to which the client device is currently connected and other networks to which the client device is connectable; and
controlling the client device to receive a push message through the determined network.

21. The method of claim 17, wherein the message delay information further comprises reception failure information on failure to receive the push message through the network to which the client device was connected at the time when the push message was transmitted, and
the controlling comprises, when the network identification information of the network to which the client device was connected at the time when the push message was transmitted is different from network identification information of a network to which the client device was connected at the time of receiving the push message, determining that the reception of the push message through the network to which the client device was connected at the time when the push message was transmitted has failed.

22. The method of claim 21, wherein the controlling comprises
determining, based on the delay time, the network identification information, and the reception failure information which are included in the message delay information, a network to use for push message reception among the network to which the client device is currently connected and other networks to which the client device is connectable; and
controlling the client device to receive a push message through the determined network.

23. The method of claim 17, wherein the message delay information further includes doze mode state information of the client device, and
the controlling comprises determining that the client device is in doze mode state when the client device has failed to receive a message corresponding to the push message from the message server after receiving the push message.

24. The method of claim 23, wherein the controlling comprises controlling, based on the doze mode state information, the client device to provide a notification message for doze mode exception handling to a user.
